(19) United States
(12) Patent Application Publication
(10) Pub. No.: US 2009/0228943 A1
(43) Pub. Date: Sep. 10, 2009

(54) System and method for delivery of personalized mosaic multimedia content over a cable data network

(76) Inventors: Kumar Ramaswamy, Princeton, NJ (US); Alan Jay Stein, Princeton Junction, NJ (US)

Correspondence Address: Thomson Licensing LLC, P.O. Box 5312, Two Independence Way, PRINCETON, NJ, 08543-5312, US

(21) Appl. No.: 12/308,216

(22) PCT Filed: Jun. 29, 2007
(86) PCT No.: PCT/US2007/015231

§ 371 Date: Dec. 9, 2008

Related U.S. Application Data
(60) Provisional application No. 60/817,787, filed on Jun. 30, 2006.

(51) Int. Cl. H04N 7/173

(52) U.S. Cl. 725/109

(57) ABSTRACT

An apparatus for providing a mosaic view in a cable Internet Protocol (IP) network is provided including a mosaic server, disposed at a cable head end, configured for receiving standard streams and mosaic streams over a cable network and selecting desired mosaic streams for forming a personalized mosaic view. A processing unit is provided configured for sending requests to the mosaic server for mosaic streams in accordance with user preferences.

### CROSS-REFERENCE TO RELATED APPLICATIONS

This application claims the benefit of U.S. Provisional Application Ser. No. 60/817,787, filed Jun. 30, 2006, which is incorporated by reference herein in its entirety.

### TECHNICAL FIELD

The present invention relates generally to broadcast media, and more particularly, to a system and method for providing and delivering personalized mosaic views comprising audio and video content in a video system.

### BACKGROUND

IPTV (Internet Protocol Television) is a system where a digital television service is delivered by using Internet Protocol (IP) over a network infrastructure, which may include delivery by a broadband connection. Generally, IPTV is television content that is received by the viewer through the technologies used for computer networks rather than through conventional broadcast and cable formats.

One of the desirable features offered by IPTV service providers is the ability to offer a customized mosaic channel view to the user, in which video content of a plurality of channels is viewed simultaneously on a single screen. This may be accomplished in, e.g., an IPTV over DSL system, since, based on the user's preference(s), a mosaic stream may be composed in the network before being sent to each home set top box (STB). In such systems, the desired mosaic streams are selected at the head end and transmitted to the home STB. The home STB then processes the received mosaic streams and builds the desired mosaic view. However, such an arrangement requires multiple mosaic streams to be transmitted to, and processed by, the individual STBs.

Indeed, personalized video mosaic display is a highly desirable, differentiating feature of IPTV solutions, compared with traditional cable/satellite TV offerings. IPTV systems enable the end-user device (e.g. a set-top box) to join multiple IP streams dynamically and combine them in real-time ‘on-the-fly’ at the end-user device.

In satellite or other one-way broadcast systems, in order to be able to compose the most arbitrary combinations of channels in a mosaic, it is necessary to carry all the mosaic streams in a single transponder or carrier. A broadcast receiver tuner then tunes to the specific channel and extracts and decodes the mosaic channels of interest and composes them for display. However, as the number of channels increase, it may become impossible to carry all the mosaic data on a single carrier. For example, on a cable system, a practical limit may be up to 200 channels (e.g., 200 Kbits/sec/mosaic channel in a single 6 MHz carrier delivering about 40 Mbits/sec of payload).

Cable Multi Service Operators (MSOs) now offer both traditional TV and high-speed Internet (HSI) data services. While traditional pay-TV solutions are now capable of combining several channels into a simultaneous mosaic view, this is performed at the cable head-end and the channel selection is static.

While current practice in digital cable has the ability to broadcast specific static combinations of mosaic views, this is not desirable for a consumer who may want a more personalized mosaic view. For example, it would be highly desirable for each mosaic view and even individual channel placements to be based on, e.g., individual user profiles or preferences and to be user-programmable using, e.g., a personal computer or via an interface on a television set.

Accordingly, a system and method for providing personalized mosaic video views that may be customized in real-time by a user in an efficient and effective manner, namely via a two-way or cable data path or network, would be highly desirable.

### SUMMARY

A method, apparatus and system in accordance with various embodiments of the present invention addresses the deficiencies, drawbacks and disadvantages of the prior art by providing a system and method for composing and delivering personalized mosaic views applicable for, e.g., two-way cable systems. For example, a two-way IP data channel may be used to deliver a personalized mosaic stream that was composed for the specific user at a mosaic server in a network proximate to the cable modem termination system (CMTS). Note that a CMTS is equipment typically found in a cable company's headend or hubsite and is used to provide high speed data services, such as cable internet for Voice over IP, for cable subscribers. The delivery of a personalized mosaic stream requires the set top box to receive and process a stream to generate the personalized mosaic view, rather than multiple streams.

Advantageously, a system and method according to an aspect of the present principles utilizes a (two-way) cable data path for transmission and selection of ‘reduced-size streams’ (video streams at a lower resolution) that can be aggregated into a personalized mosaic display that is further customizable in real-time by a user.

According to one aspect, a “mosaic server” is advantageously provided to create and deliver a personalized mosaic view to a user's set top box (STB).

According to one aspect of the present principles, an apparatus for providing a mosaic view in a television system comprises: a mosaic server coupled to a first network and adapted to receive a plurality of video program streams and a plurality of mosaic streams; and a communication interface, coupled to the mosaic server, and a plurality of user devices via a second network, the mosaic server adapted to receive via the communications interface a request for a mosaic view from one the plurality of user devices, wherein in response to the request, the mosaic server selects desired ones of the plurality of mosaic streams, generates a personalized mosaic view, and transmits the personalized mosaic view to the one of the plurality of user devices.

According to another aspect of the present principles, a method for providing a mosaic view in a video system comprises the steps of: receiving a plurality of mosaic video streams via a first network; receiving a request from one of a plurality of user devices via a second network; selecting desired ones of the plurality of mosaic video streams in response to the request; generating a personalized mosaic view from the selected ones of the plurality of mosaic video stream; and providing the generated personalized mosaic streams to the one of the plurality of user devices.

According to another aspect of the present principles, a video apparatus, comprises: a receiver coupled to a first network for receiving an encoded video signal; a decoder coupled to the receiver for decoding the encoded video signal and providing an output signal suitable for display; user input means receiving user entered commands; communications interface coupled to a mosaic server; and processor coupled to the user input means and the communications interface for causing a request for a personalized mosaic view to be transmitted to the mosaic server in response to a user entered command, the request configured to cause the mosaic server to select desired ones of a plurality of mosaic streams to generate a personalized mosaic stream that is to be provided to the apparatus, the decoder processing the personalized mosaic steam to provide the personalized mosaic view.

According to another aspect of the present principles, a method of generating a mosaic view in a video system, comprises: receiving a user request to generate a personalized mosaic view; transmitting the user request to a mosaic server, the user request configured to cause the mosaic server to select desired ones of a plurality of mosaic streams to generate a personalized mosaic stream; receiving the personalized mosaic stream from the mosaic server; and generating the personalized mosaic view in response to the personalized mosaic stream. These and other aspects, features and advantages of the present principles will be described or become apparent from the following detailed description of the preferred embodiments, which is to be read in connection with the accompanying drawings.

### BRIEF DESCRIPTION OF THE DRAWINGS

The advantages, nature, and various additional features of the invention will appear more fully upon consideration of the illustrative embodiments now to be described in detail in connection with accompanying drawings wherein:

FIG. 1 depicts an exemplary block diagram of a system for providing a personalized mosaic stream over a cable data network according to an aspect of the present principles; and

FIG. 2 is a flow diagram of a method for providing a personalized mosaic view over a cable data network in accordance with an aspect of the present principles.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

A system and method according to an aspect of the present principles advantageously is configured to utilize a (two-way) cable data path for transmission and selection of user-desired reduced-size streams that can be aggregated into a personalized and customizable mosaic video/audio display. DOCSIS (Data Over Cable Service Interface Specifications) signaling is one exemplary interface that may be used, although it is to be noted that a system and method according to the present principles extends to any signaling mechanism, and is not necessarily limited to IP, preferably so long as there is a two-way channel.

A “mosaic server” is advantageously provided preferably disposed at a head end, or service provider facilities, and configured to create and deliver a personalized mosaic view to a user's set top box (STB). Such personalized mosaic view is customized in accordance with user preferences and is further configurable in real-time according to the user's preferences. Note that a set top box used in accordance with the present system and method preferably includes a data connection (e.g., Ethernet, Wifi, etc.) in addition to a traditional video input.

It should be understood that the elements shown in the FIGS. may be implemented in various forms of hardware, software or combinations thereof. Preferably, these elements are implemented in a combination of hardware and software on one or more appropriately programmed general-purpose devices, which may include a processor, memory and input/output interfaces.

It will be appreciated that those skilled in the art will be able to devise various arrangements that, although not explicitly described or shown herein, embody the principles of the invention and are included within its spirit and scope. All examples and conditional language recited herein are intended for pedagogical purposes to aid the reader in understanding the principles of the invention and the concepts contributed by the inventor to furthering the art, and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative components embodying principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. It is thus regarded that any means that can provide those functionalities are equivalent to those shown herein.

Details of the individual block components making up the system architecture are known to skilled artisans, and will only be described in details sufficient for an understanding of the present invention.

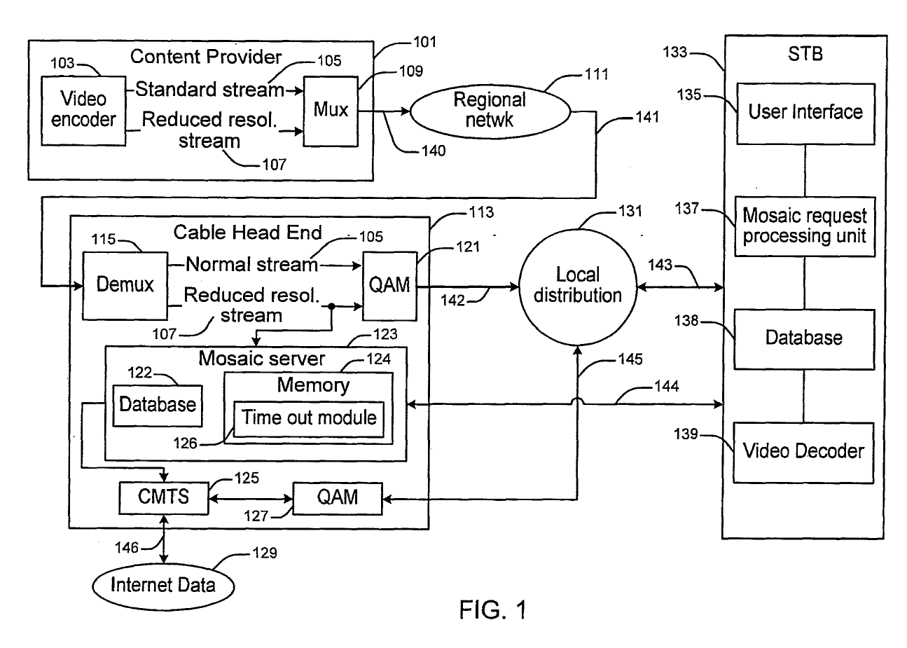

Referring now in specific detail to the drawings in which like reference numerals identify similar or identical elements throughout the several views, and initially to FIG. 1, showing an exemplary block diagram of a system 100 for providing a mosaic stream over a cable data network according to an aspect of the present principles. A content provider 101 provides content streams, e.g., cable TV content (e.g., at least a video stream at a standard or ‘normal’ resolution 105 and a video-stream at a reduced-size/resolution 107 compared with normal stream 105) which has been encoded via video encoder 103 and sent through a multiplexor 109 over a regional network 111 to a cable head-end or hubsite 113.

The cable head-end 113 receives content from the regional network 111. Such content includes, e.g., at least both standard (standard definition (SD) or high definition (HD)) streams 105 as well as reduced-resolution streams 107 at the head-end video/audio encoding stage. The reduced-resolution streams 107 may comprise secondary, simulcast video streams at a lower spatial resolution which are used in such applications as building mosaic displays as well as, e.g., picture-in-picture views.

The standard streams 105 and reduced-resolution streams 107 may be transmitted over a suitable transmission network, such as conventional local cable distribution system 131 to a home network, decoded and rendered on a set-top box 133. For example, the head end 113 recovers the multiplexed signal at a demultiplexing device (DEMUX) 115 and the standard and reduced-size streams 105, 107 are sent to QAM 121 for quadrature amplitude modulation where they are subsequently transmitted via local distribution network 131 to the set top box (STB) 133.

According to an aspect of the present principles, a mosaic server 123 is provided which receives as input the reduced-resolution streams 107. For example, the reduced resolution streams 107 are tapped off and streamed to the mosaic server 123. The mosaic server 123 is preferably connected to a cable data path; for exemplary purposes, it is shown in FIG. 1 as being connected directly to a Cable Modem Termination System 125 (CMTS) for simplicity. As the cable head end 113 is described herein as being capable of providing Internet access to subscribers, it is to be contemplated that the head-end 113 as such includes all the necessary computer system components and/or databases to provide Internet access, e.g., namely at least a cable modem termination system (CMTS) component, which sends and receives digital cable modem signals on a cable network and is necessary for providing Internet services to cable subscribers.

The mosaic server 123 monitors video requests which are sent from a mosaic request processing unit 137 in the set-top box 133, and generates a personalized mosaic stream that is transmitted to set top box 133. To generate the personalized mosaic stream, mosaic server 123 selects the desired ones of the reduced-resolution streams 107 in accordance with the user requests/preferences to build a personalized mosaic view. This mosaic view is encapsulated in a personalized mosaic stream that is transmitted over a cable Internet Protocol (IP) network 129 to the STB 133, where video decoder 139 decodes the personalized mosaic stream, and software processing via the mosaic request processing unit 137 assembles a personalized mosaic view for display to the user.

By providing a personalized mosaic stream to the STB133, the bandwidth required for transmitting the mosaic view is advantageously reduced since multiple reduced resolution streams need not be transmitted to each STB 133. Also, processing is advantageously simplified at the STB 133 since the STB 133 merely needs to receive and process a single personalized mosaic stream, rather than receiving multiple mosaic streams and building a mosaic view based on the multiple streams.

According to one aspect, the personalized mosaic view may be delivered on a separate out-of-band channel (a dedicated ‘mosaic channel’) which may comprise, e.g., a selection from the services available on an electronic program guide (EPG) or electronic content guide (ECG) in a digital cable environment, with a broadcast channel being used for normal television programming.

According to another aspect, multiple personalized mosaic views may be created and delivered to multiple users via a single set top box. Thus, advantageously, any of a plurality of different user-defined mosaic views may be automatically created and/or provided on demand depending on the current user. Additionally, a system and method according to the present principles, for example, may be configured to so as to provide different users with individual usernames and/or passwords to access their customized mosaic views.

The mosaic server 123 may also include a memory 124 for storing a ‘time-out module’ 126 for implementing a time-out mechanism configured to automatically discontinue the personalized mosaic stream from being delivered over the IP network (data channel) if, for example, a user fails to select a single channel in the mosaic view within a predefined amount of time.

The mosaic server 123 may further include a database 122 for storing, e.g., user profiles including information relating to e.g., user channel or content preferences, etc., as well as a user-defined and/or default predefined amount of time in which a time-out mechanism for the mosaic view is to be activated. Alternatively, user preferences and/or profiles, including predefined amounts of time for activating the time-out mechanism, may be stored in a database 138 situated in the set top box 133.

The set top box 133 may further include a user interface 135 for facilitating entry of user information, such as a username and/or password, as well as facilitating the creation of and amendments to user profile information for a single or multiple users. As described above, user profile information may be stored locally in the set top box 133 in database 138.

Note that a system according to the present principles enables a user to set up, create and input a user profile on alternate devices (e.g., such as a personal computer) connected to IP network 129, in addition to entering and changing a user profile via a TV set connection with STB 133.

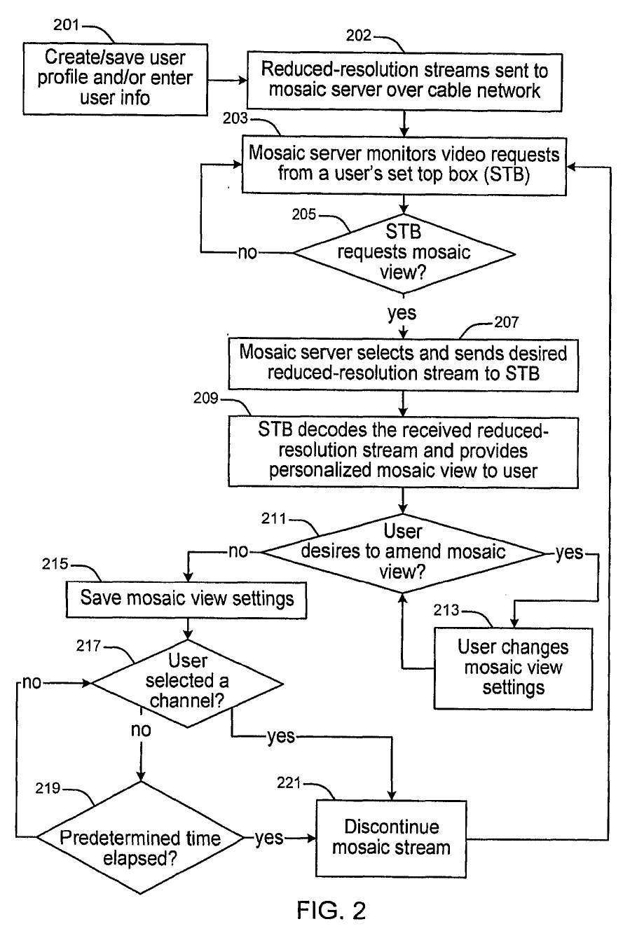

FIG. 2 is a flow diagram of an exemplary method for providing a personalized mosaic view over a cable data network in accordance with an aspect of the present principles. In step 201, a user may create and save a user profile, and/or enter user information, such as a username and/or password, television channel and/or content preferences, viewing history, a predetermined amount of time that is desired to elapse before a time-out mechanism is activated, etc.

It is to be noted that it is preferable to create/save a user profile (as per step 201) prior to a user request of a mosaic view, although the creation of a user profile and/or entry of a username/password may be performed at any time. In one embodiment, the user may be prompted to enter a username/password when a mosaic view is requested.

In step 202, all reduced-size (reduced-resolution) streams are input to a mosaic server over a cable data (IP) network. Preferably, the mosaic server continuously monitors any incoming mosaic video requests from a set top box (step 203). In decision step 205, it is determined whether a request for a mosaic view from a set top box has been received. If a mosaic view request has been received, the mosaic server selects the desired reduced-resolution (‘mosaic’) streams in accordance with the mosaic request to the STB, builds a personalized mosaic view and provides a personalized mosaic stream to the STB (step 207). Preferably, the mosaic stream comprises a video stream at a reduced spatial resolution which corresponds with, e.g., the specific plurality of channels requested in the mosaic view.

The set top box receives and decodes the personalized mosaic stream and provides a personalized mosaic view which is displayed to the user (step 209). In decision step 211, it is ascertained whether the user desires to amend the mosaic view by, e.g., selecting alternate channels to be included in the mosaic. If yes, the user makes the desired changes to the mosaic view, which may comprise the user selecting one of the areas on the display which are of less interest and clicking to select another channel. The process returns to step 211, where it is determined whether further changes to the mosaic view are desired to be made. Preferably, the process loops between steps 211 and 213 until the mosaic view is finalized by the user.

When a user is satisfied with the mosaic view and no additional or further changes are desired, the mosaic view settings may be saved in a database, e.g., disposed at the set top box or at the mosaic server (step 215). The process proceeds to step 217, in which it is determined whether the user has selected a channel for, e.g., full screen viewing. Depending on whether or not the user has selected, e.g., a single channel for viewing, a mosaic view ‘time-out’ mechanism may be automatically activated.

For example, if the user desires to watch one of the channels in the mosaic view, the user may click directly on the mosaic view using, e.g., a remote control device or mouse on the area of interest. Clicking on the area of interest in the mosaic view may cause selection of the channel corresponding to same. Additional information may be transmitted with the personalized mosaic stream to enable the STB to correlate the portion of the screen selected by the user with specific channels displayed on the mosaic view. Upon making a channel selection, the mosaic stream may be automatically stopped (step 221) so as to discontinue the stream of reduced-resolution video from being sent via the Internet data path to the set top box. Advantageously, the time-out mechanism enables bandwidth being used by the mosaic view to be restored to the internet data service in the event that the mosaic view is no longer needed or being viewed by a user. Accordingly, bandwidth would not be wasted on a mosaic display that is not actually being watched.

If no channel selection has been made by a user, it is determined whether a predetermined time period has elapsed (step 219). Such predetermined period of time may comprise a user-defined time period or, for example, a system default (e.g., about 5-10 minutes) if a user-defined amount is not specified. If the predetermined amount of time has not yet elapsed, the process loops back to step 217, in which the system ascertains whether the user has selected at least one channel for full screen viewing. The process continues thereon as described above.

If the desired/default predefined time period has elapsed, the process proceeds to step 221, in which the mosaic video stream is discontinued. The process may then loop back to step 203, in which the mosaic server continuously monitors any further video requests from the set top box.

To further illustrate the concept, an exemplary sequence or flow of a method of accessing and providing a personalized mosaic view on a cable data network may comprise at least the following steps:

1) A user powers a set top box operably connected to a mosaic server at a cable headend and having at least a data connection, and selects “mosaic video display.”

2) The set top box requests the transmission of a personalized mosaic view from the cable IP network. The reduced-resolution streams are selected by the mosaic server in accordance with user preferences, e.g., based on the last several channels viewed by the user, or comprise a default set of reduced-resolution streams saved at the set top box. The transmission of the personalized mosaic stream may be done using, e.g., IGMP protocol, which joins or leaves multicast flows, however other mechanisms may be used.

3) The mosaic server transmits the personalized mosaic stream to the set top box, for example, via IP multicast (though unicast solutions are possible as well).

4) At any time, the user may select alternate channels to be included in the mosaic view, for example, by navigating with a remote control or point-and-click device to the screen area which is of less interest, and selecting an alternate channel to take its place. The selection of an alternate channel may be facilitated by, for example, accessing a menu for selecting a different channel from a plurality of channels to display in its place, or ‘right-clicking’ on the point-and-click device to access such menu or select another channel directly.

5) Such dynamic channel selection process for revising the mosaic view may be continued until the user is satisfied with the personalized choices and the resultant mosaic view, at which time he could save the mosaic settings. The mosaic setting may be saved at the mosaic server and/or the individual STB.

Note that while IP multicast and Internet Group Management Protocol (IGMP) for IPTV-like systems may be used in a system and method according to the present principles, transmission control protocol (TCP) or HTTP (Internet video) protocols may also be utilized. Concepts according to the present principles are independent of the protocol families used. For example, a simple IGMP join message for a specific user preference combination may assist in selecting the specific streams and delivering the personalized mosaic stream which is decoded and displayed in any arbitrarily customer chosen mosaic. A set top box in accordance with the present principles preferably includes at least a data connection, via e.g., Ethernet or a wireless local area network such as wireless fidelity (Wi-Fi), in additional to a video input (e.g., s-video, RCA analog composite, etc.)

Having described preferred embodiments for a system and method for providing a personalized mosaic view over a cable data network (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. For example, the request to the mosaic server for a personalized mosaic view could be transmitted via separate channels, or even via a separate medium than the transmission medium of the program signals, for example, via communication channel 144 of FIG. 1. Also, the user preferences for building the personalized mosaic view may be saved at a data base associated with the mosaic server and/or at the individual set top box. Also, although the embodiment is described in the context of a cable network, it is clear that the principles of the mosaic server are applicable to other types of IP video networks, including, but not limited to DSL, and satellite. Having thus described the invention with the details and particularity required by the patent laws, what is claimed and desired protected by Letters Patent is set forth in the appended claims.

1. An apparatus for providing a mosaic view in a cable Internet Protocol (IP) network, comprising:
a mosaic server, disposed at a cable head end, configured for receiving standard streams and mosaic streams over a cable network and selecting desired mosaic streams for forming a personalized mosaic view; and
a processing unit configured for sending requests to the mosaic server for mosaic streams in accordance with user preferences over the cable IP network.

2. The apparatus of claim 1, wherein the user preferences comprise at least one of previously viewed channels and user-defined desired channels.

3. The apparatus of claim 1, wherein said processing unit is in operable communication with a database configured for storing the user preferences.

4. The apparatus of claim 1, wherein said mosaic streams comprise video streams at a lower spatial resolution than the standard streams.

5. The apparatus of claim 1, wherein said processing unit is disposed in a set top box having at least a cable data connection.

6. The apparatus of claim 1, wherein the mosaic server further comprises a database for storing user information.

7. The apparatus of claim 6, wherein said user information includes at least one of a user profile and a predetermined amount of time.

8. The apparatus of claim 1, wherein the mosaic server further includes a memory for storing a time-out module configured for disabling the mosaic view after a predetermined amount of time has elapsed.

9. The apparatus of claim 1, wherein the desired mosaic streams for forming the personalized mosaic view are delivered to the processing unit via the cable IP network.

10. A method for providing a mosaic view in a cable Internet Protocol (IP) network, comprising the steps of:
receiving mosaic video streams over a cable network;
monitoring video requests;
sending personalized mosaic streams over the cable IP network in accordance with a video request; and
providing the mosaic view based on the personalized mosaic streams to a user.

11. The method of claim 10, wherein the step of receiving mosaic streams includes receiving standard video streams over a cable network, wherein the mosaic streams comprise secondary video streams having a lower spatial resolution than the standard streams.

12. The method of claim 10, wherein the step of sending personalized mosaic streams comprises:
receiving a mosaic video request from a mosaic processing unit; and
selecting desired mosaic streams in accordance with each mosaic video request.

13. The method of claim 12, wherein the step of selecting the desired mosaic streams comprises selecting mosaic streams in accordance with user preferences, wherein the user preferences comprise at least one of previously viewed channels and user-defined desired channels.

14. The method of claim 13, further comprising the step of providing a database in operable communication with a processing unit, the database being configured for storing the user preferences.

15. The method of claim 10, wherein said processing unit is disposed in a set top box having a cable data connection.

16. The method of claim 10, wherein the mosaic server further comprises a database for storing user information.

17. The method of claim 16, wherein said user information includes at least one of a user profile and a predetermined amount of time.

18. The method of claim 10, wherein the mosaic server further includes a memory having a time-out module configured for disabling the mosaic view after a predetermined amount of time has elapsed.

19. The method of claim 10, further comprising the steps of:
determining if the mosaic view is desired to be amended, wherein if no, further comprising the steps of:
saving the mosaic view; and
determining if the user has selected a channel in the mosaic view, wherein if yes, further comprising the step of discontinuing the mosaic stream.

20. The method of claim 19, wherein if the user has not selected a channel in the mosaic view, further comprising the step of determining if a predetermined time period has elapsed, wherein if yes, further comprising the step of discontinuing the mosaic stream.
